(19) United States
(12) Patent Application Publication
(10) Pub. No.: US 2007/0062042 A1
(43) Pub. Date: Mar. 22, 2007

(54) Fluid applicator on an electric hair removal apparatus and a filling station for the fluid applicator

(76) Inventors: Christof Kleemann, Eschborn (DE); Jurgen Wolf, Kriftel (DE)

Correspondence Address: FISH & RICHARDSON PC, P.O. BOX 1022, MINNEAPOLIS, MN, 55440-1022, US

(21) Appl. No.: 11/523,999

(22) Filed: Sep. 20, 2006

Related U.S. Application Data
(63) Continuation of application No. PCT/EP05/01046, filed on Feb. 3, 2005.

(30) Foreign Application Priority Data
Mar. 31, 2004 (DE) 10 2004 015 759.6

(51) Int. Cl. B26B 19/28

(52) U.S. Cl. 30/45

(57) ABSTRACT

An electrical hair removal apparatus for partially or fully removing hair from the skin. The hair removal apparatus has a housing and an application element arranged outside of the housing to apply a fluid onto the skin. The application element is embodied as a fluid reservoir that receives the total fluid reserve of the hair removal apparatus.

### CROSS REFERENCE TO RELATED APPLICATIONS

This application is a continuation of PCT application serial number PCT/EP2005/001046, filed Feb. 3, 2005, which claims priority under 35 U.S.C. §119(a) from German application serial number DE 10 2004 015 759.6, filed Mar. 31, 2004, the entire contents of both of which are hereby incorporated by reference.

### TECHNICAL FIELD

This invention relates to a fluid applicator on an electric hair removal apparatus and a filling station for the fluid applicator.

### BACKGROUND

Electrical hair removal apparatuses, which apply a fluid onto the user's skin, have been described in various patents and patent applications. For example, WO 98/55274 A1 describes a personal body care system, which includes a cartridge for storing a fluid, and an appliance. The appliance has a treatment device for performing a treatment on the user's body by means of the fluid, and an interface for coupling the cartridge to the appliance. Furthermore, the appliance has a blocking device for blocking at least one function of the appliance. The cartridge has a key which cooperates with the blocking device such that the blocking device enables the operation of the appliance when the cartridge is fitted. Fluid can be fed from the cartridge to the user's skin by means of a pump. The purpose of the blocking device is to prevent the use of an unsuitable fluid.

WO 02/064328 A1 discloses a personal care system which includes a personal care appliance and a refill unit. The care appliance comprises an outlet and a first reservoir which is connected to the outlet and has a refill inlet. The refill unit comprises a refill outlet, which can be coupled to the first reservoirs refill inlet, in order to refill the first reservoir of the care appliance. Also, the refill unit comprises a second reservoir and means for conveying the fluid from the second reservoir to the first reservoir when the personal care appliance is coupled to the refill unit. The refill unit is provided in a holder for storing the care appliance when it is not in use.

DE 199 07 025 A1 describes a hair removal apparatus with a fluid transport system, which enables fluid to be stored and dispensed independently of position and movement. The fluid transport system has a fluid reservoir, an actuatable pump device (with a pump inlet port and a pump outlet port), and a fluid dispensing device designed for wetting a person's skin and/or hairs with fluid. The fluid dispensing device is adapted to be coupled via a first fluid line to the pump inlet port and via a second fluid line to the fluid reservoir and can include a contact element made of an open-pore material used for dispensing the fluid.

These hair removal apparatuses each have relatively complex devices for storing the fluid in the hair removal apparatus and for applying the fluid onto the user's skin. As a result, considerable constructional changes are required compared to hair removal apparatuses that do not have the additional functionality. Furthermore, it is necessary in each case to provide a considerable amount of space in the hair removal apparatus for the required components.

### SUMMARY

One aspect of the invention features electrical hair removal apparatus for partially or fully removing hair from the skin that has a housing and an application element arranged outside of the housing to apply a fluid onto the skin. The application element is embodied as a fluid reservoir that receives the total fluid reserve of the hair removal apparatus.

The present invention can provide the advantage, in various embodiments, of requiring only little additional expenditure to achieve a similar effect as elaborate hair removal apparatuses with fluid application. It can be particularly advantageous with the hair removal apparatus of the invention that no infrastructure such as a reservoir, a pump, connecting lines etc. is required for the application element, making it possible to upgrade practically any hair removal apparatus with relatively little expenditure. Furthermore, no space need be required for the infrastructure, enabling the hair removal apparatus to be constructed with a handy and elegant design.

The hair removal apparatus is constructed such that the application element can be filled with the fluid solely from outside the housing. In some embodiments, the application element can be impregnated with the fluid. This makes filling easy and enables a very simple constructional design of the application element. In some embodiments, the application element is an absorbent material, and is constructed as a sponge or a wick, for example. Furthermore, the hair removal apparatus may be constructed such that the application element dispenses fluid on making contact with the skin.

In some embodiments, the apparatus has a shaving head in which the application element is integrated. For example, the application element may be arranged to the side of an outer cutter of the shaving head. In some embodiments, the application element is arranged in the region between two adjacent outer cutters of the shaving head. The application element may extend in each case over the full width of the outer cutter such that fluid is applied onto the skin in the entire effective range of the outer cutter.

Another aspect of the invention relates to a filling station for an electrical hair removal apparatus, such as a shaver or epilator, for partially or fully removing hair from the skin. The hair removal apparatus has a housing and an application element arranged outside the housing to apply a fluid onto the skin. The filling station has a filling element for filling the application element with the fluid.

An advantage of the illustrated filling station is its straightforward construction, enabling the application element to be filled quickly with fluid.

In some embodiments, the filling element is a fluid-permeable material and can be connected to a fluid reservoir. In this arrangement the filling station is constructed such that fluid can be fed from the fluid reservoir to the filling element. In some embodiments of the filling station, the filling element is arranged in a holding device for holding the hair removal apparatus in the region of the application element. The holding device can be constructed to be movable between a first and a second position. In some embodiments, the holding device can be movable from the first into the second position by means of a mechanical action of the hair removal apparatus. Through movement of the holding device from the first into the second position, it is possible for fluid to be fed from the fluid reservoir to the filling element. In this arrangement, the holding device can be biased toward the first position by an elastic element. With this construction of the filling station, the application element can be filled in a very user-friendly manner.

In some embodiments, the filling station has an upper and a lower fluid chamber, which have a connecting channel between the two chambers. Moving the holding device from the first position to the second position increases the pressure in the upper fluid chamber. The increased pressure in the upper fluid chamber is communicated to the lower fluid chamber via the connecting channel. A second channel connects the lower fluid chamber and the filling element. The increased pressure in the lower fluid chamber pumps fluid from the lower fluid chamber through the second channel into the filling element. A valve allows the upper fluid chamber to communicate with the atmospheric pressure when the holding device is in the first position, and isolates the upper chamber from communicating with the atmospheric pressure when the holding device is moved to the second position.

In a further aspect, the filling station includes a charger for supplying a charging current to the hair removal apparatus. Similarly, the filling station may include a cleaning device for cleaning the hair removal apparatus.

The fluid which is successively dispensed upon filling the application element can be replaced in various ways. For example, the filling station can have a replaceable reservoir for the fluid. In some embodiments, it is possible for the filling station to have an inlet for refilling the fluid. In other embodiments, the filling station is constructed as a disposable item.

In a system having an electrical hair removal apparatus and a filling station, the hair removal apparatus and/or the filling station are constructed as described hereinabove. In particular, the hair removal apparatus can be accommodated by the filling station such that the application element of the hair removal apparatus touches and rests against the filling element of the filling station.

A method of filling an electrical hair removal apparatus with a fluid includes placing an electrical hair removal apparatus, having a housing and an application element, in a hair removal apparatus filling station. The filling station has a receptacle positioned in a holding device, and an upper fluid chamber and a lower fluid chamber connected to each other by a first channel. The receptacle has a filling element connected by a second channel to the lower fluid chamber, and arranged to fill the application element of the apparatus with the fluid. Moving the holding device from a first position to a second position increases the pressure in the upper fluid chamber, the increased pressure is communicated to the lower fluid chamber by the first channel. The application element is filled when the increased pressure pumps the fluid from the lower fluid chamber through the second channel into the filling element.

Other aspects, features, and advantages will be apparent from the following detailed description, the drawings, and the claims.

### BRIEF DESCRIPTION OF THE DRAWINGS

FIG. 1 is a perspective view of an embodiment of an electric shaver;

FIG. 2 is a perspective view of an embodiment of a filling station for filling the application element of the shaver;

FIG. 3 is a sectional view of the embodiment of the filling station shown in FIG. 2;

FIG. 4 is another sectional view of the embodiment of the filling station shown in FIG. 2; and

FIG. 5 is an enlarged detail view of FIG. 4.

### DETAILED DESCRIPTION

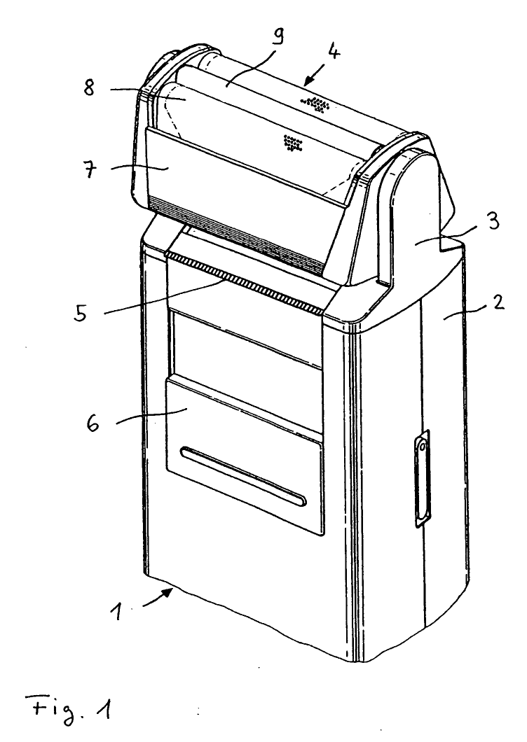

FIG. 1 shows in a perspective representation an embodiment of an electric shaver 1. The shaver 1 has a housing 2 with two mutually spaced supports 3 on which a shaving head 4 is pivotally suspended. Also arranged on the housing 2 are a long hair cutter 5 and a switch 6 for switching on and off the shaver 1 and for sliding out the long hair cutter 5. The shaving head 4 has a removable exchangeable frame 7 in which two shaving foils 8 are secured in tension in arched shape. Arranged in the region between the two shaving foils 8 is an application element 9 which extends over the full width of the shaving foils 8. With regard to its height, the application element 9 is flush with the shaving foils 8 or projects slightly above them. The application element 9 is an absorbent material, for example in the form of a sponge or a wick, which is able to store fluid.

Alternatively to the embodiment shown in FIG. 1, in which the application element 9 is substituted for a central cutter arranged intermediate the two shaving foils 8, the application element 9 can also be arranged in a number of other positions. For example, the application element 9 can be arranged to the side of the central cutter such that the central cutter continues to exist. Similarly, it is also possible for the application element 9 to be arranged to the side of the shaving head 4 and hence for it to be positioned ahead of one of the two shaving foils 8. In this case, provision can also be made for two application elements 9, each positioned ahead of one of the shaving foils 8, respectively. In another embodiment, the application element 9 is arranged in a position corresponding to the long hair cutter 5 and can be extended as required.

During use of the shaver 1, the application element 9 serves to apply fluid, which is stored in the shaver, onto the user's skin. For this purpose the application element 9 is constructed such that it dispenses fluid on making contact with the skin. Depending on the construction of the application element 9, fluid is dispensed upon simple contact with the skin without any pressure or it is not dispensed until the application element 9 is actually pressed against the skin. A pump or a similar fluid impelling device is not required in either case. The fluid is dispensed even against gravity, enabling the shaver 1 to be handled in the usual way. In the absence of contact with the skin, no fluid will be dispensed, even when the shaver 1 is held by the user such that the shaving head 4, and hence the application element 9, face downward.

The fluid stored in the application element 9 serves to assist the shaving operation. For this purpose the fluid is composed, for example, to improve the sliding properties of the shaving foils 8 on the skin and to leave the user with a feeling of freshness. Similarly, the fluid can also have a disinfecting effect. The fluid does not necessarily have to be thin-bodied, but can display a relatively high viscosity such as a lotion, in some embodiments.

As no reservoir is provided in the housing 2 of the shaver 1, only the quantity of fluid stored in the application element 9 is available in each case. Depending on the construction of the application element 9 this quantity may suffice for one complete shaving operation, meaning that the application element 9 does not have to be refilled with fluid until the next shaving operation. However, in some embodiments, it may become necessary during the shaving operation to fill the application element 9 with fluid, and then to continue shaving. The device described below can be used for filling the application element 9 with fluid.

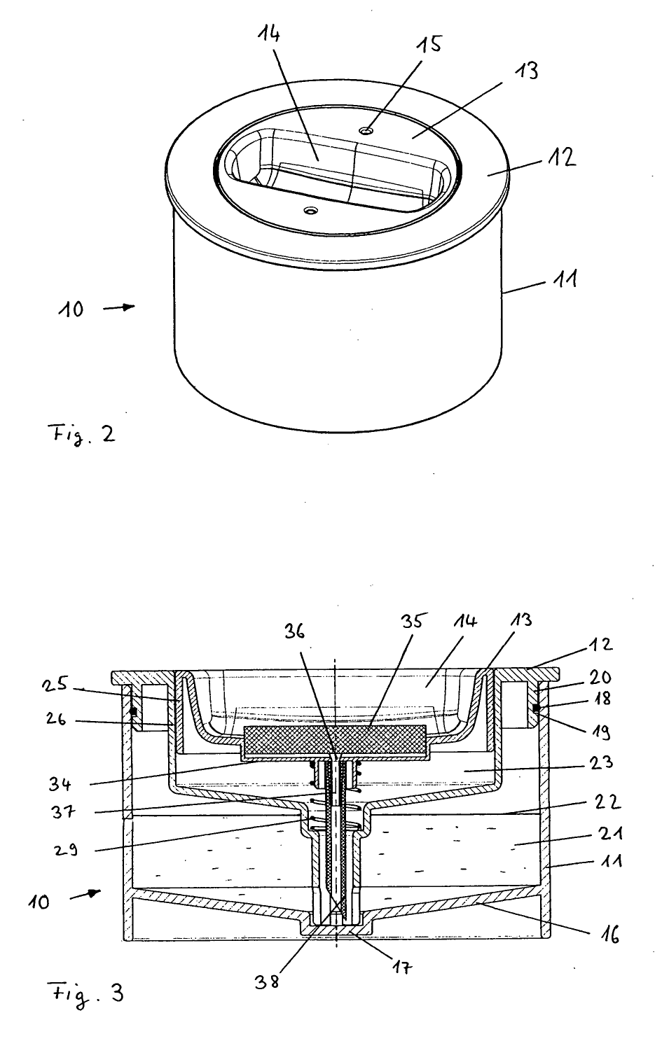

FIG. 2 shows in a perspective representation an embodiment of a filling station 10 constructed for filling the application element 9 of the shaver 1. In some embodiments, the filling station 10 has a lower part 11 of hollow cylindrical construction, which is closed by an upper part 12. Integrated in the upper part 12 is an insert 13 which comprises a well 14 of trough-shaped construction for receiving the shaving head 4 of the shaver 1. Also, two perforations 15 are drawn in the region of the upper part 12. Only one perforation 15 is required. However, two embodiments of a mechanism for closing the perforations 15 are described in the following description, one of the embodiments being assigned to one of the two perforations 15, respectively.

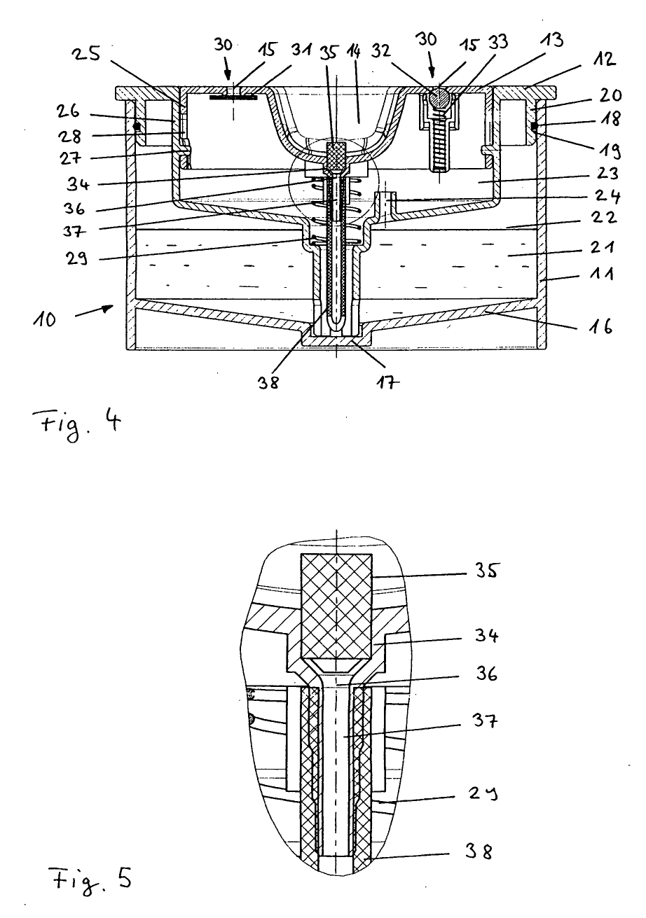

FIG. 3 shows, in a sectional representation, the embodiment of the filling station 10 presented in FIG. 2. Another sectional representation of the filling station 10, in which the sectional plane is turned 90 degrees around the vertical relative to FIG. 3, is shown in FIG. 4. The lower part 11 of the filling station 10 comprises a conically shaped bottom 16 with a cylindrical central region 17 which forms the deepest point of the bottom 16. The lower part 11 is sealed against the upper part 12 by an O-ring 18 which is inserted in an annular circumferential radial groove 19 of an external cylindrical section 20 of the upper part 12. The upper part 12 has the shape of a multiple-step funnel which leads into the central region 17 of the bottom 16 of the lower part 11. Together with the lower part 11 the upper part 12 encloses a lower chamber 21 filled with fluid. Before the application element 9 is filled for the first time, the lower chamber 21 is filled with fluid up to a filling level 22. Together with the insert 13 the upper part 12 also encloses an upper chamber 23 which is arranged above the lower chamber 21. The lower chamber 21 and the upper chamber 23 are connected to each other by a connecting channel 24 formed in the upper part 12.

The insert 13 is arranged for displacement in the upper part 12 and for this purpose has a cylindrical wall section 25 which is slidably movable within a cylindrical receiving section 26 of the upper part 12. The sliding movement extends in vertical direction with the filling station 10 set up on a horizontal base. Formed on the cylindrical receiving section 26 are two radially inwardly pointing journals 27 which engage in corresponding elongated holes 28 of the insert 13. This limits the stroke of the sliding movement of the insert 13 relative to the upper part 12, and securely captures the insert 13 on the upper part 12. Also, twisting of the insert 13 relative to the upper part 12 is prevented. The insert 13 takes support upon the upper part 12 parallel to the sliding direction by means of a compression spring 29 so that for the insert 13 to be moved relative to the upper part 12 out of the position shown in FIGS. 3 and 4 it is necessary to overcome the restoring force of the compression spring 29, and the compression spring 29 urges the insert 13 back into its initial position when no external force acts on the insert 13 any more.

The perforations 15 in the insert 13 are each closed by means of a vent valve 30. There are two embodiments of the vent valve 30 depicted in FIG. 4. In some implementations of the filling station 10, there is only one perforation 15 which is closed by means of a vent valve 30, according to one of these embodiments. In the case of the embodiment of the vent valve 30 presented on the left, the perforation 15 is closed by a flap 31 resting against the inside of the insert 13. The flap is comprised of an elastic material and is fastened to the insert 13 in a region alongside the perforation 15 in a way not shown in the Figure. Given a pressure below atmospheric in the upper chamber 23 relative to the environment, the flap 31 lifts partially off the insert 13 and, as this occurs, opens the perforation 15 in part, thus enabling pressure equalization with the environment. Due to its elasticity, the flap 31 then closes the perforation 15 again. Given a pressure above atmospheric in the upper chamber 23 relative to the environment, the flap 31 is pressed against the insert 13 and continues to close the perforation 15, thus preventing pressure equalization via the perforation 15. The flap 31, thus has the effect of reducing a pressure below atmospheric in the upper chamber 23 whilst maintaining a pressure above atmospheric. The same function is implemented on the embodiment of the vent valve 30 presented on the right, in this case by means of a ball 32 which is pressed by a valve spring 33 against the inside of the insert 13 and hence closes the perforation 15. Through a pressure below atmospheric in the upper chamber 23 the restoring force of the valve spring 33 can be overcome, with the result that the ball 32 opens the perforation 15. Given a pressure above atmospheric in the upper chamber 23 the ball 32 is pressed even more firmly against the insert 13, thus keeping the perforation 15 closed.

Constructed at the bottom of the well 14 of the insert 13 is a groove 34 into which a filling element 35 is inserted such that it projects partly out of the groove 34. The filling element 35 is constructed to be fluid-permeable, for example in the form of a wick or a porous material. In some embodiments, the filling element 35 can have on its upper side a depression which extends horizontally over its entire length and is connected to a central through-bore extending in vertical direction. Formed centrally relative to the groove 34 at the bottom of the groove 34 of the insert 13 is a supply inlet 36 via which a neck 37 leads into the groove 34. Fastened to the neck 37 is a flexible hose 38 which extends inside the upper part 12 into the vicinity of the central region 17 at the bottom 16 of the lower part 11 and is beveled at its free end. The region of the neck 37 and of the groove 34 is shown in FIG. 5 as an enlarged detail of FIG. 4.

The application element 9 of the shaver 1 is filled by means of the filling station 10 as follows: the shaving head 4 of the shaver 1 is inserted into the well 14 of the filling station 10 until it rests against the bottom of the well 14, as the result of which a touching contact is established between the application element 9 of the shaver 1 and the filling element 35 of the filling station 10. Then the insert 13 is pushed downward manually, by exerting a corresponding force on the shaver 1 to overcome the restoring force of the compression spring 29, until the insert 13 impacts in the region of the elongated holes 28 against the journals 27 of the upper part 12. The volume of the upper chamber 23 of the filling station 10 is thus reduced. As it is impossible for the air inside the upper chamber 23 to escape via the closed vent valve 30, the reduction of volume causes the pressure in the upper chamber 23 to increase. As the result, pressure equalization between the upper chamber 23 and the lower chamber 21 occurs via the connecting channel 24, thus producing also in the lower chamber 21 a pressure above atmospheric relative to the environment. The pressure above atmospheric in the lower chamber 21 results in fluid being displaced from the lower chamber 21 via the free end of the hose 38 into the hose 38, causing the level of fluid in the hose 38 to rise. Via the neck 37 and the supply inlet 36, the fluid reaches the filling element 35, impregnates it and emerges again at its surface.

A directionalized discharge of fluid on the upper side of the filling element 35 can be achieved, for example, by manufacturing the filling element 35 from a fibrous material with which the fluid is transferred in a direction parallel to the fibers. In this case, the fibers extend from the lower side to the upper side of the filling element 35. In some embodiments, it is possible to equip the filling element 35 on the side with a coating which is non-permeable, or only very slightly permeable for the fluid. Also, the filling element 35 can be constructed in such a manner that fluid emerges only where the application element 9 rests against the filling element 35. The previously mentioned embodiment of the filling element 35, where provision is made for a depression and a through-bore, likewise results in an emergence of fluid on the upper side of the filling element 35.

The fluid exiting from the filling element 35 is picked up by the application element 9 which rests against the upper side of the filling element 35. As this occurs, the shaving foils 8 are not wetted with fluid. The discharge of fluid is proportional to the reduction of the pressure in the lower chamber 21 and the upper chamber 23 of the filling station 10.

After the insert 13 has impacted against the journals 27 and has dwelled in this position for a short period of time during which the application element 9 is filled with fluid, the act of exerting force on the shaver 1 is ended, and the shaving head 4 is removed from the well 14 of the filling station 10. As the result, the insert 13 is moved back into its initial position by the restoring force of the compression spring 29. The volume of the upper chamber 23 is thus increased and the pressure drops accordingly. A pressure below atmospheric pressure which may develop in the upper chamber 23 relative to the environment causes the vent valve 30 to open. As a result, air flows into the upper chamber 23 from the environment causing an equalization of the pressure.

In some embodiments to enable a defined filling of the application element 9, the stroke defined by the elongated holes 28 of the insert 13 can be coordinated with the application element 9 such that the amount of fluid displaced by depressing the insert 13 once suffices to fill the application element 9 completely. Provision can also be made for the application element 9 to be filled by depressing the insert 13 several times, without the shaving head 4 of the shaver 1 being removed from the well 14 in the meantime.

In some embodiments, the compression spring 29, which returns the insert 13 into its initial position, is dimensioned such that the shaver 1 does not have to be actively depressed in order to fill the application element 9 with fluid, instead the dead weight of the shaver 1 suffices to move the insert. 13 as far as its end position. In this embodiment, the shaver 1 is simply deposited, with its shaving head 4 to the front, in the well 14 of the filling station 10. The insert 13 then moves without manual intervention to the end position, thus filling the application element 9 of the shaver 1 with fluid. Finally, the shaver 1 is withdrawn from the well 14 of the filling station 10 and the insert 13, actuated by the compression spring 29, returns into its initial position. After the application element 9 has been filled with fluid, the user can begin or continue shaving with the shaver. Through the repeat filling of the application element 9 of the shaver 1, the filling station 10 is gradually emptied. When the filling level 22 of the fluid in the lower chamber 21 has dropped to the point where further filling of the application element 9 is no longer possible, the user proceeds differently, depending on the construction of the filling station 10. According to some embodiments, the filling station 10 is disposed of completely and replaced by a new filling station 10 filled with fluid. According to other embodiments, a replaceable reservoir for the fluid is taken out of the filling station 10 and replaced by a new reservoir filled with fluid. This embodiment requires a number of constructional adaptations of the previously described embodiment of the filling station 10. In another embodiment, the filling station 10 is topped up with the aid of a refill bottle. This requires a corresponding inlet on the filling station 10.

In some embodiments, the filling station 10 can be developed further so that it has, a charger for the shaver 1. For this purpose the filling station 10 can have, in a region outside the insert 13, a holding device for receiving the shaver 1 by its end opposite the shaving head 4. A provision is made for charging contacts on the shaver 1, which are electrically contacted by corresponding contacts of the charger in the region of the holding device.

In some embodiments, the filling station 10 can also be combined with a cleaning station for the shaving head 4 of the shaver 1. In this embodiment, it is possible to provide a single fluid circuit, and to fill the application element 9 of the shaver 1 with the same fluid which is also used for cleaning the shaving head 4. In other embodiments, it is possible to provide two fluid circuits such that the application element 9 of the shaver 1 can be filled with a different fluid than the cleaning fluid.

A number of embodiments of the invention have been described. Nevertheless, it will be understood that various modification may be made without departing from the spirit and scope of the invention. For example, the invention is suitable not only for a shaver 1 but also for an epilator (not illustrated). Moreover, the shape and size of the filling station may take on any form consistent with the disclosure herein. Accordingly, other embodiments are within the scope of the following claims.

1. An electrical hair removal apparatus for partially or fully removing hair from the skin, the apparatus comprising:
a housing; and
an application element arranged outside of the housing to apply a fluid onto the skin;
wherein the application element comprises a fluid reservoir configured to receive a total fluid reserve of the hair removal apparatus.

2. The hair removal apparatus according to claim 1, wherein the application element is constructed to be filled with the fluid solely from outside the housing.

3. The hair removal apparatus according to claim 1, wherein the application element is constructed to be impregnated with the fluid.

4. The hair removal apparatus according to claim 1, wherein the application element comprises an absorbent material.

5. The hair removal apparatus according to claim 1, wherein the application element is constructed as a sponge.

6. The hair removal apparatus according to claim 1, wherein the application element dispenses fluid on making contact with the skin.

7. The hair removal apparatus according to claim 1, further comprising a shaving head, wherein the application element is integrated into the shaving head.

8. The hair removal apparatus according to claim 7, wherein the application element is arranged alongside of an outer cutter of the shaving head.

9. The hair removal apparatus according to claim 7, wherein the application element is arranged in the region between two adjacent outer cutters of the shaving head.

10. The hair removal apparatus according to claim 8, wherein the application element extends over a full width of the outer cutter.

11. The hair removal apparatus according to claim 1, wherein the application element is constructed as a wick.

12. An electrical hair removal apparatus filling station comprising:
a receptacle configured to receive an electrical hair removal apparatus having a housing and an application element arranged outside of the housing to apply a fluid onto the skin; and
a filling element positioned in the receptacle and arranged to fill the application element with the fluid.

13. The filling station according to claim 12, wherein the filling element comprises a fluid-permeable material.

14. The filling station according to claim 12, wherein the filling element is connected to a fluid reservoir.

15. The filling station according to claim 14, wherein fluid is fed from the fluid reservoir to the filling element.

16. The filling station according to claim 12, wherein the receptacle is arranged in a holding device.

17. The filling station according to claim 16, wherein the holding device is constructed to be movable between a first and a second position.

18. The filling station according to claim 17, wherein the holding device is movable from the first into the second position by means of a mechanical action of the hair removal apparatus.

19. The filling station according to claim 18, wherein through movement of the holding device from the first into the second position fluid is fed from the fluid reservoir to the filling element.

20. The filling station according to claim 17, wherein the holding device is biased toward the first position by an elastic element.

21. The filling station according to claim 12, further comprising a charger for supplying a charging current to the hair removal apparatus.

22. The filling station according to claim 12, further comprising a cleaning device for cleaning the hair removal apparatus.

23. The filling station according to claim 12, further comprising a replaceable reservoir for the fluid.

24. The filling station according to claim 12, further comprising an inlet for refilling the fluid.

25. The filling station according to claim 12, wherein the filling station is constructed as a disposable item.

26. The filling station according to claim 17 further comprising an upper and a lower fluid chamber having a connecting channel therebetween, wherein moving the holding device from the first position to the second position increases pressure in the upper fluid chamber, the increased pressure being communicated to the lower fluid chamber via the connecting channel.

27. The filling station according to claim 26 further comprising a second channel between the lower fluid chamber and the filling element, such that the increased pressure in the lower fluid chamber pumps fluid from the lower fluid chamber through the second channel into the filling element.

28. The filling station according to claim 27 further comprising a valve designed to provide a communication between atmospheric pressure and the upper fluid chamber when the holding device is in the first position and to isolate the upper chamber from communicating with the atmospheric pressure when the holding device is moved to the second position.

29. A hair removal system comprising;
an electrical hair removal apparatus comprising a housing and an application element arranged outside of the housing to apply a fluid onto the skin and embodied as a fluid reservoir that receives a total fluid reserve of the hair removal apparatus; and
a filling station configured to receive the electric hair removal apparatus, the filling station comprising a filling element arranged to fill the application element with fluid.

30. The system according to claim 29, wherein the hair removal apparatus is received by the filling station in such a way that the application element of the hair removal apparatus touches and rests against the filling element of the filling station.

31. A method of filling an electrical hair removal apparatus with a fluid, the method comprising:
placing an electrical hair removal apparatus, having a housing and an application element, in a hair removal apparatus filling station, having a receptacle positioned in a holding device and an upper fluid chamber and a lower fluid chamber connected to each other by a first channel, the receptacle having a filling element connected by a second channel to the lower fluid chamber and arranged to fill the application element of the apparatus with the fluid;
moving the holding device from a first position to a second position increases pressure in the upper fluid chamber, the increased pressure being communicated to the lower fluid chamber by the first channel; and
filling the application element with the fluid pumped by the increased pressure from the lower fluid chamber through the second channel into the filling element.
